(19) United States
(12) Patent Application Publication
(10) Pub. No.: US 2015/0026568 A1
(43) Pub. Date: Jan. 22, 2015

(54) METHOD AND APPARATUS OF TRUNCATING CHARACTER STRING

(71) Applicant: TENCENT TECHNOLOGY (SHENZHEN) COMPANY LIMITED, Shenzhen (CN)

(72) Inventors: YI ZHAO, Shenzhen (CN); JIAZHONG SHEN, Shenzhen (CN)

(73) Assignee: TENCENT TECHNOLOGY (SHENZHEN) COMPANY LIMITED

(21) Appl. No.: 14/462,790

(22) Filed: Aug. 19, 2014

Related U.S. Application Data
(63) Continuation of application No. PCT/CN2014/077532, filed on May 15, 2014.

(30) Foreign Application Priority Data
Jul. 18, 2013 (CN) 2013103027798

(51) Int. Cl. G06F 17/24

(52) U.S. Cl. CPC G06F 17/24
USPC 715/254

(57) ABSTRACT

Methods, apparatus, and terminal devices for truncating a character string are provided. A character string to be truncate is read and a byte length occupied by a current character is obtained. It is determined whether a substring, formed from a starting character of the character string to be truncated to the current character, satisfies a pre-set truncating condition. When the substring, formed from the starting character of the character string to be truncated to the current character, satisfies the pre-set truncating condition, the current character is subtracted from the substring to generate a truncated substring for displaying, according to the byte length occupied by the current character.

### CROSS-REFERENCES TO RELATED APPLICATIONS

This application is a continuation application of PCT Patent Application No. PCT/CN2014/077532, filed on May 15, 2014, which claims priority to Chinese Patent Application No. 2013103027798, filed on Jul. 18, 2013, the entire contents of which are incorporated herein by reference.

### FIELD OF THE DISCLOSURE

The present disclosure generally relates to the field of computer technology and, more particularly, relates to methods, apparatus, and terminal devices of truncating a character string.

### BACKGROUND

Application programs often have an interface for displaying. Due to limitations on control size of interface text and on design of positions, character strings having various lengths need to be truncated for displaying in the text control. Currently, a limitation of a maximum number of bytes is pre-set for character strings with various lengths. When the number of bytes contained in the character strings that need to be displayed exceeds the limitation of the pre-set maximum number of bytes, the character strings need to be truncated, and only a substring having a maximum number of bytes can then be displayed. Suspension points may be added, as needed, following the substring to indicate that the displayed is a truncated substring.

However, under some circumstances of character encoding, the number of bytes occupied by different symbol characters (e.g., Chinese, English or other symbol characters) is different. When the character string is truncated directly in accordance with the maximum number of bytes, the character may be displayed as an error message/code. In addition, when displaying the character string, Chinese, English or other symbol characters that have a same number of bytes may not have a same character number. In some cases, Chinese characters may be displayed with appropriate length, while English characters may be displayed beyond the control that is pre-set.

### BRIEF SUMMARY OF THE DISCLOSURE

One aspect or embodiment of the present disclosure includes a method for truncating a character string. The method can include exemplary steps (a)-(d). A character string to be truncate is read (a) and a byte length occupied by a current character is obtained (b). It is determined whether a substring, formed from a starting character of the character string to be truncated to the current character, satisfies a pre-set truncating condition (c). When the substring, formed from the starting character of the character string to be truncated to the current character, satisfies the pre-set truncating condition, the current character is subtracted from the substring to generate a truncated substring for displaying, according to the byte length occupied by the current character (d).

When the substring, formed from the starting character of the character string to be truncated to the current character, does not satisfy the pre-set truncating condition, a next character following the current character is used as another current character to repeat steps (b)-(d) until the character string to be truncated satisfies the pre-set truncating condition, and then displaying the character string to be truncated.

Optionally, an actually-displayed pixel width of the substring, formed from the starting character of the character string to be truncated to the current character is obtained.

The step (c) of determining whether the substring, formed from the starting character of the character string to be truncated to the current character, satisfies the pre-set truncating condition includes: determining whether an actually-displayed pixel width of the substring, formed from the starting character of the character string to be truncated to the current character, is greater than a pre-set maximum pixel width. When the actually-displayed pixel width is greater than the pre-set maximum pixel width, the pre-set truncating condition is satisfied. When the actually-displayed pixel width is not greater than the pre-set maximum pixel width, the pre-set truncating condition is unsatisfied.

The step (c) of determining whether the substring formed from the starting character of the character string to be truncated to the current character satisfies the pre-set truncating condition includes: determining whether a total byte length occupied by the substring, formed from the starting character of the character string to be truncated to the current character, is greater than a pre-set maximum byte length. When the total byte length occupied by the substring is greater than the pre-set maximum byte length, the pre-set truncating condition is satisfied. When the total byte length occupied by the substring is not greater than the pre-set maximum byte length, the pre-set truncating condition is unsatisfied.

The step (b) of obtaining the byte length occupied by the current character includes: directly obtaining the byte length occupied by each character according to a coding type of the character string to be truncated, when the character string to be truncated uses fixed-length coding.

The step (b) of obtaining the byte length occupied by the current character includes: obtaining the byte length occupied by the current character according to a first byte of the current character, when the character string to be truncated uses variable-length coding.

After the step (a) of reading the character string to be truncated, the method further includes: determining whether the character string to be truncated satisfies the pre-set truncating condition. When the character string to be truncated satisfies the pre-set truncating condition, steps (b)-(d) is performed. When the character string to be truncated does not satisfy the pre-set truncating condition, the character string to be truncated is displayed directly.

To determining whether the character string to be truncated satisfies the pre-set truncating condition, an actually-displayed pixel width of the character string to be truncated is obtained. It is determined whether the actually-displayed pixel width of the character string to be truncated is greater than a pre-set maximum pixel width.

To determining whether the character string to be truncated satisfies the pre-set truncating condition, whether a total byte length occupied by the character string to be truncated is greater than a pre-set maximum byte length is determined.

Another aspect or embodiment of the present disclosure includes an apparatus for truncating a character string. The apparatus includes a first obtaining unit, a first determining unit, and a truncating unit.

The first obtaining unit is configured to read a character string to be truncated to obtain a byte length occupied by a current character. The first determining unit is configured to determine whether a substring, formed from a starting character of the character string to be truncated to the current character, satisfies a pre-set truncating condition. The truncating unit is configured to subtract the current character from the substring as a truncated substring for displaying according to the byte length occupied by the current character, when the substring, formed from the starting character of the character string to be truncated to the current character, satisfies the pre-set truncating condition.

The apparatus further includes a displaying unit. The displaying unit is configured, when the substring, formed from the starting character of the character string to be truncated to the current character, does not satisfy the pre-set truncating condition, to use a next character following the current character as another current character to repeat steps (b)-(d) performed by the first obtaining unit, the first determining unit, and the truncating unit until the character string to be truncated satisfies the pre-set truncating condition, and then to display the character string to be truncated.

The apparatus further includes a second obtaining unit. The second obtaining unit is configured to obtain an actually-displayed pixel width of the substring, formed from the starting character of the character string to be truncated to the current character.

The first determining unit is configured to determine whether an actually-displayed pixel width of the substring, formed from the starting character of the character string to be truncated to the current character, is greater than a pre-set maximum pixel width. When the actually-displayed pixel width is greater than the pre-set maximum pixel width, the pre-set truncating condition is satisfied. When the actually-displayed pixel width is not greater than the pre-set maximum pixel width, the pre-set truncating condition is unsatisfied.

The first determining unit is configured to determine whether a total byte length occupied by the substring, formed from the starting character of the character string to be truncated to the current character, is greater than a pre-set maximum byte length. When the total byte length occupied by the substring is greater than the pre-set maximum byte length, the pre-set truncating condition is satisfied. When the total byte length occupied by the substring is not greater than the pre-set maximum byte length, the pre-set truncating condition is unsatisfied.

The first obtaining unit is configured to directly obtain the byte length occupied by each character according to a coding type of the character string to be truncated, when the character string to be truncated uses fixed-length coding.

The first obtaining unit is configured to obtain the byte length occupied by the current character according to a first byte of the current character, when the character string to be truncated uses variable-length coding.

The further includes a second determining unit. The second determining unit is configured to determine whether the character string to be truncated satisfies the pre-set truncating condition. When the character string to be truncated satisfies the pre-set truncating condition, the first obtaining unit obtains the byte length occupied by the current character. When the character string to be truncated does not satisfy the pre-set truncating condition, the character string to be truncated is directly displayed.

The second determining unit is configured to obtain an actually-displayed pixel width of the character string to be truncated, and to determine whether the actually-displayed pixel width of the character string to be truncated is greater than a pre-set maximum pixel width. When the actually-displayed pixel width is greater than the pre-set maximum pixel width, the first obtaining unit obtains the byte length occupied by the current character. When the actually-displayed pixel width is not greater than the pre-set maximum pixel width, the character string to be truncated is directly displayed.

The second determining unit is configured to determine whether a total byte length occupied by the character string to be truncated is greater than a pre-set maximum byte length. When the total byte length occupied by the character string to be truncated is greater than the pre-set maximum byte length, the first obtaining unit obtains the byte length occupied by the current character. When the total byte length occupied by the character string to be truncated is not greater than the pre-set maximum byte length, the character string to be truncated is directly displayed.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIGS. 1A-1B provide conventional displaying results of truncated character strings;

FIG. 2 depicts an exemplary method for truncating a character string consistent with various disclosed embodiments;

FIG. 3 depicts another exemplary method for truncating a character string consistent with various disclosed embodiments;

FIG. 4 depicts another exemplary method for truncating a character string consistent with various disclosed embodiments;

FIG. 5 depicts another exemplary method for truncating a character string consistent with various disclosed embodiments;

FIG. 6 depicts an exemplary displaying result of a truncated character string consistent with various disclosed embodiments;

FIG. 7 depicts an exemplary apparatus for truncating a character string consistent with various disclosed embodiments; and

FIG. 8 depicts an exemplary terminal device consistent with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

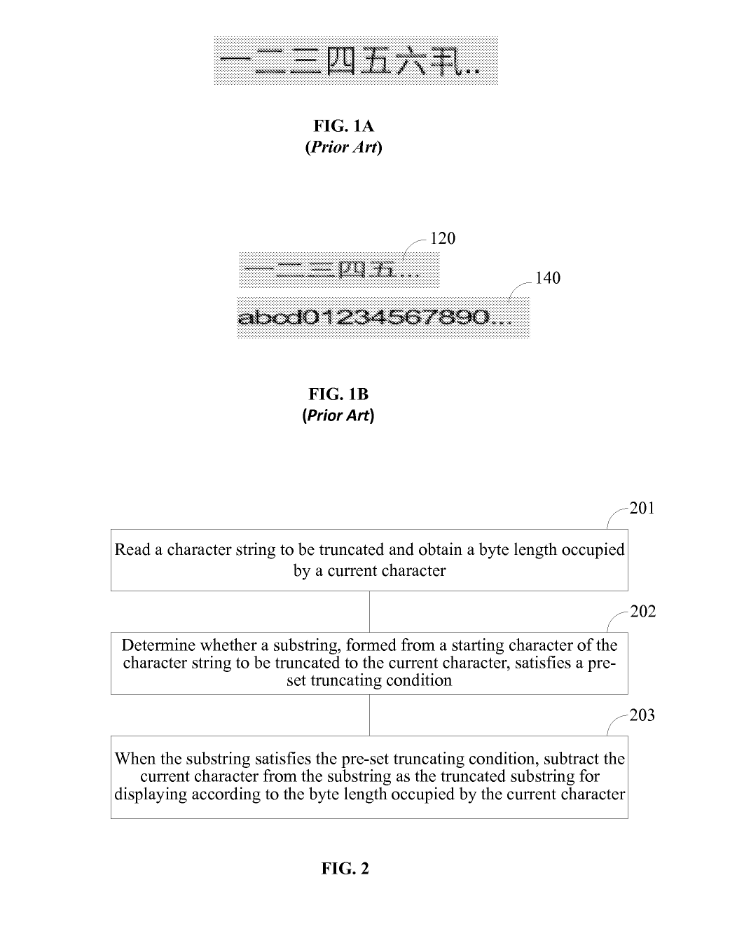

When character strings are truncated based on a pre-set maximum number of bytes, the truncated character string may be displayed in error. In some circumstances of character encoding, number of bytes occupied by a different character is different. For example, in a UTF-8 coding, one Chinese character may occupy three bytes, while one English character may occupy one byte. When the character string is truncated based on the maximum number of bytes and when the truncating position locates within the three bytes of Chinese character, the Chinese character is thus displayed in error. For example, in the UTF-8 coding, when a maximum truncated byte length is set as “MAX_CHAR_LEN=20”, a displaying result of the truncated character string of “s [symbol] ” is shown in FIG. 1A having an error code with suspension points. Note that “ [symbol] ” are Chinese characters.

In addition, a text displaying pixel width corresponding to a character string having a same number of bytes is different. When displaying a character string, Chinese, English or other symbol characters that have a same number of bytes may not have a same number of characters and the actually-displayed pixel widths are different. When truncating simply according to a maximum number of bytes, in some cases, Chinese characters may be displayed with appropriate length, while English characters may be displayed beyond the control that is pre-set. For example, in a UTF-8 coding, a maximum number of the truncated byte can be set as “MAX_CHAR_LEN=15”, displaying results of the truncated character strings of “s1= [symbol] [symbol] ” (120 in FIG. 1B) and “s2=abcd01234567890123456789” (140 in FIG. 1B) are shown in FIG. 1B. Apparently, for two character strings with a same number of bytes, the actually-displayed pixel width are different. When setting a greater value of “MAX_CHAR_LEN”, the difference will be more obvious. In this case, when the text control is designed according to a width after truncating the shorter “s1”, the width of the pre-set text control is to be exceeded when designing “s2”.

As disclosed herein, with respect to a different character code, a byte length occupied by each character can be dynamically determined to ensure the truncated character is a complete (or full) character to avoid error code displayed from a truncated substring. In addition, by using a pre-set maximum pixel width as a pre-set truncating condition, the truncated substring is ensured not to exceed a pre-set text control width.

Methods and apparatus for truncating a character string are provided. For example, the apparatus for truncating the character string can be integrated with a client, which can be loaded or installed in a terminal device (e.g., as shown in FIG. 8). The terminal device can be, e.g., a smart phone, a tablet computer, an e-book reader, a MP3 (Moving Picture Experts Group Audio Layer III, dynamic image expert compression standard Audio level 3) player, a MP4 (Moving Picture Experts Group Audio Layer IV, dynamic image expert compression standard Audio level 3) player, a laptop, a desktop computer, and/or any suitable terminal device.

FIG. 2 depicts an exemplary method for truncating a character string. In Step 201, a character string to be truncated is read to obtain a byte length occupied by a current character.

In a different character code, the number of bytes occupied by Chinese, English, or other characters can be different. To ensure that the truncated character does not include error code, it requires that the bytes contained in the truncated substring correspond to a complete character. There is, therefore, a need to obtain the byte length occupied by the character string to be truncated.

For example, a method named “computeCharLength(ch)” can be used to obtain the number of bytes that are actually-occupied by a character including a first byte of “ch”. For a different character code, the method of “computeCharLength(ch)” can be performed accordingly.

In various embodiments, the exemplary step of obtaining the byte length occupied by the current character includes: directly obtaining the byte length occupied by each character according to the coding type of the character string to be truncated, when the character string to be truncated uses fixed-length coding.

When the character string to be truncated uses fixed-length coding (e.g., in a coding that the number of bytes occupied by a character is fixed) the method of obtaining the byte length occupied by the current character is relatively simple. The byte length occupied by each character can be directly obtained, according to the coding type of the character string to be truncated. For example, UCS-2 coding is a type of fixed-length code with respect to Unicode. Unicode is a character code used in a computer and sets a unified and unique binary code. Unicode may satisfy the cross-linguistic processing requirement. Each character of UCS-2 coding can fixedly occupy 2 bytes, then the method of “computeCharLength(ch)” can return a byte length of about 2 directly, indicating that each character occupies a byte length of 2.

In various embodiments, the exemplary step of obtaining the byte length occupied by the current character includes: when the character string to be truncated uses variable-length coding, obtaining the byte length occupied by the current character according to the first byte of the current character.

For the variable-length coding, the number of bytes occupied by a current character can be determined according to the first byte “ch” of the character. For example, the UTF-8 coding is also a type of character code with respect to Unicode. Different from UCS-2 coding, the UTF-8 coding is a variable-length character code. When the read-out value of the first byte “c” is within 0-127 (e.g., when the coding format is “0XXX XXXX”, representing an English character or numeric character) a byte length corresponding to the character is about 1.

When the read-out value of the first byte “ch” falls within 224-239 (e.g., when the coding format is “1110XXXX”, representing a Chinese character) a byte length corresponding to the character is about 3. In practical applications, when the truncated character string only includes Chinese and English character strings, only two numerical ranges can be determined. When there is a need to process other types of character, the numerical range of other determinations may be appended or otherwise added by referring to a UTF-8 coding table.

In Step 202, it is determined whether a substring, formed from a starting character of the character string to be truncated to the current character, satisfies the pre-set truncating condition.

It is determined whether the substring, formed from the starting character to the current character, satisfies the pre-set truncating condition by adding up the character one after another from a starting character. The pre-set truncating condition can include whether the added-up value is greater than a pre-set maximum byte length or whether the added-up value is greater than a pre-set maximum pixel width.

In Step 203, when the substring, formed from the starting character of the character string to be truncated to the current character, satisfies the pre-set truncating condition, according to the byte length occupied by the current character, the current character is subtracted from the substring to generate a truncated substring for displaying.

When the substring, formed from the starting character of the character string to be truncated to the current character, satisfies the pre-set truncating condition, for example, when the substring, formed from the starting character of the character string to be truncated to the current character, is greater than the pre-set maximum byte length, or, when the actually-displayed pixel width of the substring, formed from the starting character of the character string to be truncated to the current character, is greater than the pre-set maximum pixel width, the character string to be truncated needs to be truncated and displayed. An exemplary truncating method includes, using another substring, formed from the starting character to a previous character of current determining character, as the truncated substring for displaying into a text control, and appending suspension points after this another substring to indicate the character string is displayed after being truncated.

As such, the character string is ensured to be truncated after an end of the character, and the truncated substring may not have error code.

In various embodiments, the method for truncating a character string further includes: when the substring, formed from the starting character of the character string to be truncated to the current character, does not satisfy the pre-set truncating condition, using the next character following the current character as another current character to repeat the method from the exemplary Step 201 of obtaining the byte length occupied by the current character, until the character string to be truncated satisfies the pre-set truncating condition. The character string to be truncated can then be displayed.

In various embodiments, after reading the character string to be truncated, the method for truncating a character string further includes: determining whether the character string to be truncated satisfies the pre-set truncating condition.

When the character string to be truncated satisfies the pre-set truncating condition, exemplary Steps (201)-(203) can be continuously implemented. When the character string to be truncated does not satisfy the pre-set truncating condition, the character string to be truncated can be displayed directly.

After reading the character string to be truncated, it is firstly determined whether the character string to be truncated needs to be truncated. When the character string to be truncated does not need to be truncated, there is no need to search for the truncating location. This can accelerate processing speed of displaying the character string.

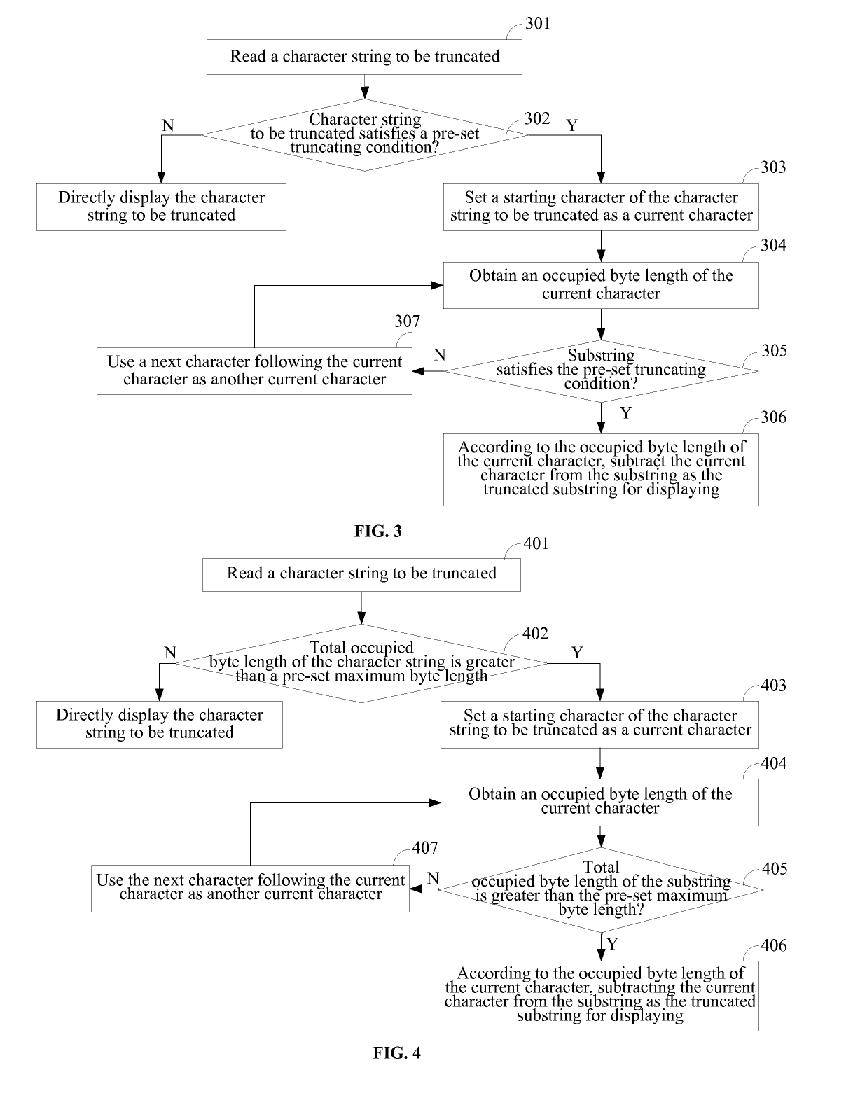

Referring to FIG. 3, the second embodiment of method for truncating the character string including exemplary steps as following. In Step 301, a character string to be truncated is read.

In Step 302, it is determined whether the character string to be truncated satisfies a pre-set truncating condition. When the character string to be truncated satisfies a pre-set truncating condition, the method proceeds to perform Step 303. When the character string to be truncated does not satisfy a pre-set truncating condition, the character string to be truncated is directly displayed.

In Step 303, a starting character of the character string to be truncated is set as a current character. In Step 304, a byte length occupied by the current character is obtained.

In Step 305, it is determined whether a substring, formed from the starting character of the character string to be truncated to the current character, satisfies the pre-set truncating condition. When the substring satisfies the pre-set truncating condition, the method proceeds to perform Step 306. When the substring does not satisfy the pre-set truncating condition, the method proceeds to perform Step 307.

In Step 306, according to the byte length occupied by the current character, the current character is subtracted from the substring to form a truncated substring for displaying. In Step 307, a next character following the current character is set as another current character. Based on this current character, the method can be repeated from Step 304 as depicted in FIG. 3.

Comparing with the method depicted in FIG. 2, the exemplary method depicted in FIG. 3 further includes: after reading the character string to be truncated, pre-determining whether the character string to be truncated satisfies the pre-set truncating condition to accelerate the processing speed. Furthermore, the exemplary method depicted in FIG. 3 includes: when the substring (formed from the starting character of the character string to be truncated to the current character) does not satisfy the pre-set truncating condition, using the next character as a current character for further determination by the method depicted herein, till an end character of the character string to be truncated is used as a current character by implementing the exemplary method of FIG. 3.

Because whether the entire character string to be truncated satisfies the pre-set truncating condition has been pre-determined, it cannot occur that: the pre-set truncating condition is still unsatisfied, until the end character is used as a current character to perform the method in FIG. 3. That is, when determining whether the entire character string to be truncated satisfies the pre-set truncating condition, the step of determining whether the substring (formed from the starting character of the character string to be truncated to the current character) satisfies the pre-set truncating condition is actually a procedure of finding the truncating location. Because the byte length occupied by each character that is before the current character has been obtained, when truncating the character string, the truncation can be performed according to the split of characters. Error code can be avoided.

In various embodiments, the method for truncating the character string further includes: obtaining an actually-displayed pixel width of the substring, formed from the starting character of the character string to be truncated to the current character.

For example, “computePixelofString(s)” can be used to denote the actually-displayed pixel width of the character string s in the text control. The property of text control can be called to obtain the actually-displayed pixel width. For example, in an IOS developing system, the property “textureRect.size.width” of the text control “CCLabelTTF” can be called to obtain the actually-displayed pixel width of the character string in the text control.

In various embodiments, wherein the exemplary step of determining whether the substring, formed from the starting character of the character string to be truncated to the current character, satisfies the pre-set truncating condition can include: determining whether the actually-displayed pixel width of the substring, formed from the starting character of the character string to be truncated to the current character, is greater than the pre-set maximum pixel width.

When the actually-displayed pixel width is greater than the pre-set maximum pixel width, the pre-set truncating condition is satisfied. When the actually-displayed pixel width is not greater than the pre-set maximum pixel width, the pre-set truncating condition is unsatisfied.

In various embodiments, wherein the step of determining whether the substring, formed from the starting character of the character string to be truncated to the current character, satisfies the pre-set truncating condition can include: determining whether a total byte length occupied by the substring, formed from the starting character of the character string to be truncated to the current character, is greater than a pre-set maximum byte length.

When the total byte length occupied by the substring is greater than the pre-set maximum byte length, the pre-set truncating condition is satisfied. When the total byte length occupied by the substring is not greater than the pre-set maximum byte length, the pre-set truncating condition is unsatisfied.

In other words, the pre-set truncating condition can be whether that is greater than the pre-set maximum byte length or whether that is greater than the pre-set maximum pixel width. In an exemplary embodiment, the pre-set truncating condition is whether that is greater than the pre-set maximum pixel width. Considering numbers of bytes occupied by English and Chinese character are different and also considering the difference of the actually-displayed pixel widths, by using the pre-set maximum pixel width for truncating the character string, normal displaying of the interface text can be provided.

Similarly, in various embodiments, the exemplary step of determining whether the character string to be truncated satisfies the pre-set truncating condition includes: obtaining the actually-displayed pixel width of the character string to be truncated, and determining whether the actually-displayed pixel width of the character string to be truncated is greater than the pre-set maximum pixel width.

In various embodiments, the exemplary step of determining whether the character string to be truncated satisfies the pre-set truncating condition includes: determining whether the total byte length occupied by the character string to be truncated is greater than the pre-set maximum byte length.

For example, the pre-determination of whether the character string to be truncated satisfies the pre-set truncating condition can be performed using at least two exemplary methods. One method includes determining whether the actually-displayed pixel width of the character string to be truncated is greater than the pre-set maximum pixel width. The other method includes determining whether the total byte length occupied by the character string to be truncated is greater than the pre-set maximum byte length.

Referring to FIG. 4, when the pre-set truncating condition is whether a total byte length occupied by a substring is greater than a pre-set maximum byte length, the exemplary method can include additional exemplary steps.

In Step 401, a character string to be truncated is read. In Step 402, it is determined whether a total byte length occupied by the character string to be truncated is greater than a pre-set maximum byte length. When the total byte length occupied by the character string to be truncated is greater than the pre-set maximum byte length, the method proceeds to perform Step 403. When the total byte length occupied by the character string to be truncated is not greater than the pre-set maximum byte length, the character string to be truncated is directly displayed.

In Step 403, the starting character of the character string to be truncated is set as a current character. In Step 404, a byte length occupied by the current character is obtained. In Step 405, it is determined whether the total byte length occupied by the substring, formed from the starting character of the character string to be truncated to the current character, is greater than the pre-set maximum byte length. When the total byte length occupied by the substring is greater than the pre-set maximum byte length, the method proceeds to perform Step 406. When the total byte length occupied by the substring is not greater than the pre-set maximum byte length, the method proceeds to perform Step 407.

In Step 406, according to the byte length occupied by the current character, the current character is subtracted from the substring to generate a truncated substring for displaying. In Step 407, a next character following the current character is used as another current character, to perform the method from, e.g., the exemplary Step 404.

In one embodiment, a given character string s can be read, starting from a first byte s[0]. The byte length occupied by the character including s[0] can be calculated to be l=computeCharLength(s[0]). For example, a number l of bytes starting from the byte s[0] can correspond to one character, which cannot be truncated. Therefore, the next character can have a starting byte with a location of s[0+l]=s[l], and so on, to calculate the byte length occupied by the character including s[l].

In an example for UTF-8 coding, the method for dynamically truncating a character string can be performed. Given a character string mixed with Chinese and English, e.g., “s=a [symbol] b [symbol] ” (note: [symbol] and [symbol] are Chinese characters), a maximum byte length can be set as 6, starting from a first byte s[0]=97. Because s[0] is within 0-127, “computeCharLength(s[0])” returns an occupied byte length of about 1. A total byte length from the starting character to the current character can be about 1. Continuously determining “s[0+1]=s[1]=228”, which is within 224-239, the “computeCharLength(s[1])” returns an occupied byte length of about 3. In other words, the three bytes of s[1], s[2], and s[3] together can form one character. A total byte length from the starting character to the current character can be about 4.

Continuing a next determination of byte “s[1+3]=s[4]=98”, a contained byte length is about 1. A total byte length from the starting character to the current character is about 5. Continuously determining “s[4+1]=s[5]=228”, the contained byte length is about 3, a total byte length from the starting character to the current character is about 8 and is greater than the maximum byte length. Then the truncating can be performed at a location after end of the third character.

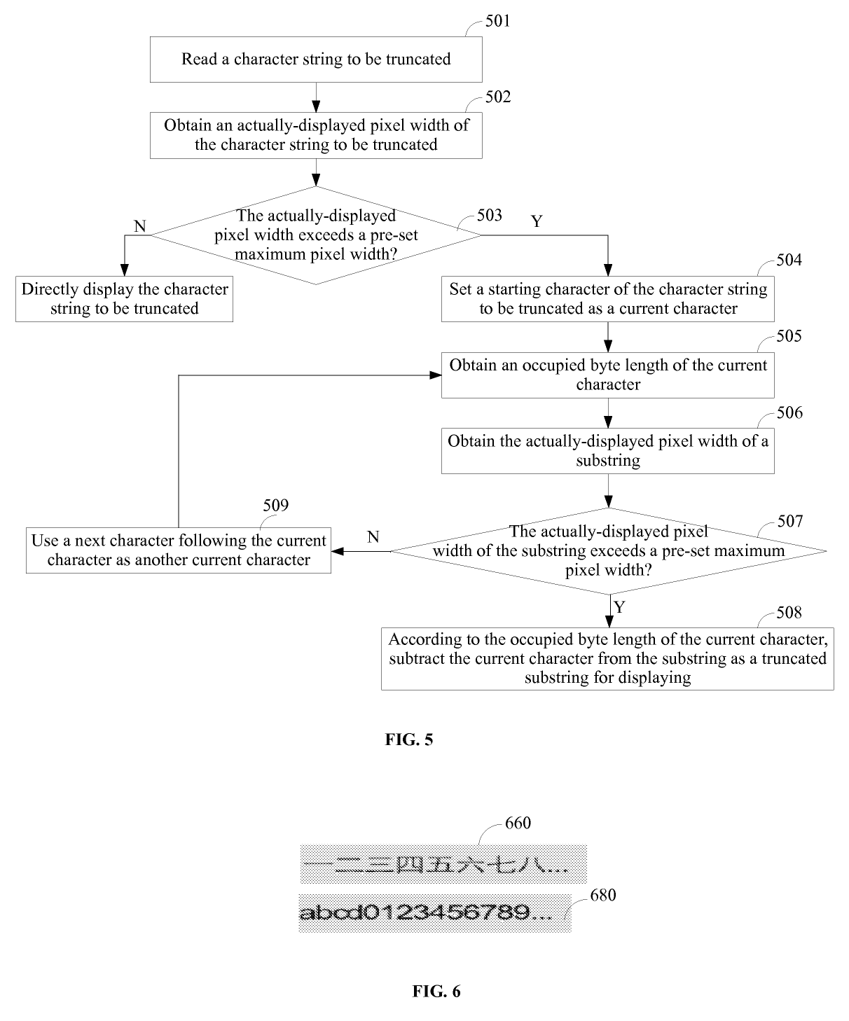

Referring to FIG. 5, when the pre-set truncating condition is whether an actually-displayed pixel width is greater than a pre-set maximum pixel width, the exemplary method for truncating the character string in FIG. 4 can include additional exemplary steps.

In Step 501, a character string to be truncated is read. In Step 502, an actually-displayed pixel width of the character string to be truncated is obtained.

In Step 503, it is determined whether the actually-displayed pixel width of the character string to be truncated is greater than a pre-set maximum pixel width. When the actually-displayed pixel width is greater than the pre-set maximum pixel width, the method proceeds to implement Step 504. When the actually-displayed pixel width is not greater than the pre-set maximum pixel width, the character string to be truncated is directly displayed.

In Step 504, a starting character of the character string to be truncated is set as a current character. In Step 505, a byte length occupied by the current character is obtained. In Step 506, the actually-displayed pixel width of the substring formed from the starting character of the character string to be truncated to the current character is obtained.

In Step 507, it is determined whether the actually-displayed pixel width of the substring formed from the starting character of the character string to be truncated to the current character is greater than the pre-set maximum pixel width. When the actually-displayed pixel width is greater than the pre-set maximum pixel width, the method proceeds to implement Step 508. When the actually-displayed pixel width is not greater than the pre-set maximum pixel width, the method proceeds to implement Step 509.

In Step 508, according to the byte length occupied by the current character, the current character is subtracted from the substring to generate a truncated substring for displaying. In Step 509, a next character following the current character is used as another current character to repeat the disclosed method, e.g., from Step 505.

For a given character string s, the drawn pixel width “computePixelofString(s)” is firstly calculated whether is greater than the pre-set maximum pixel width “MAX_PIXEL_LEN”. When the drawn pixel width is not greater than the pre-set maximum pixel width, the character string s can be directly displayed to the text control without truncating. When the drawn pixel width is greater than the maximum pixel width “MAX_PIXEL_LEN”, while determining each character, the actually-displayed pixel width from the starting character of the character string s to the substring s* corresponding to current character can be calculated. If the “computePixelofString(s*)” does not exceed the “MAX_PIXEL_LEN”, taking the next character for a continuing determining. If the “computePixelofString(s*)” exceeds the “MAX_PIXEL_LEN”, the string from the starting character to a previous character of current determined character can be used as the truncated substring for displaying into the text control. In addition, suspension points can be added after this substring to indicate that the character string is displayed after being truncated.

For example, for a given character string to be truncated s, firstly the displayed pixel width “computePixelofString(s)” can be calculated. When the displayed pixel width does not exceed “MAX_PIXEL_LEN”, there is no need to truncating and the method can directly return to s. When the displayed pixel width exceeds “MAX_PIXEL_LEN”, “index” is used to mark the current determined byte location. As the initial “index”=0, the byte length of a character having “s[index]” as a first byte can be calculated as l=computeCharLength(s[index]). When the byte corresponding to current determined character is from “s[index]” to “s[index+l−1]” (i.e., not including “s[index+l]”), a substring s* can be taken from “s[0]” to “s[index+l−1]”. The displayed pixel width “computePixelofString(s*)” can then be calculated. When the displayed pixel width does not exceed “MAX_PIXEL_LEN”, the “index” can be set as “index+l”. Such process can be repeated to continue determining the next character. Otherwise, the substring from “s[0]” to “s[index−1]” (i.e., not including “s[index]”) can be returned as the truncated character string. When needed, suspension points can be added after this substring to indicate that the character string is displayed after being truncated.

For example, in UTF-8 coding, the maximum pixel width can be set as “MAX_PIXEL_LEN=160”. After being truncated using the disclosed methods, the displaying of character string “s1= [symbol] ” (where “ [symbol] ” 660 in FIG. 6 are Chinese character) and “s2=abcd01234567890123456789” (see 680 in FIG. 6) can be shown in FIG. 6. As shown, the displayed width of these two character strings is different. In addition, as the truncated character string is often followed by suspension points for indicating that being truncated. Therefore, when designing the text control, a width corresponding to the text control needs to be slightly greater than “MAX_PIXEL_LEN”.

Further, the disclosed method for truncating character string, compared with a directly truncating method, may increase the time used for determining each character and for calculating a pixel width. However, because the disclosed processing is a linear process, while in practical applications only about tens of characters may need to be processed at the most, the increased time may not affect the performance.

As such, the disclosed method can dynamically obtain the byte length occupied by each character of the character string to be truncated. When truncating the character string, when a substring (e.g., formed from the starting character of the character string to be truncated to the current character) satisfies a pre-set truncating condition, the current character can be subtracted from the substring as the truncated substring for displaying to ensure a complete character without having error code. In addition, according to an actual pixel width of the character, a maximum pixel width can be set to truncate the character string, to ensure the displayed-width service of the character string (containing different types of characters) after a final truncation is in line with the requirement set by the text control width.

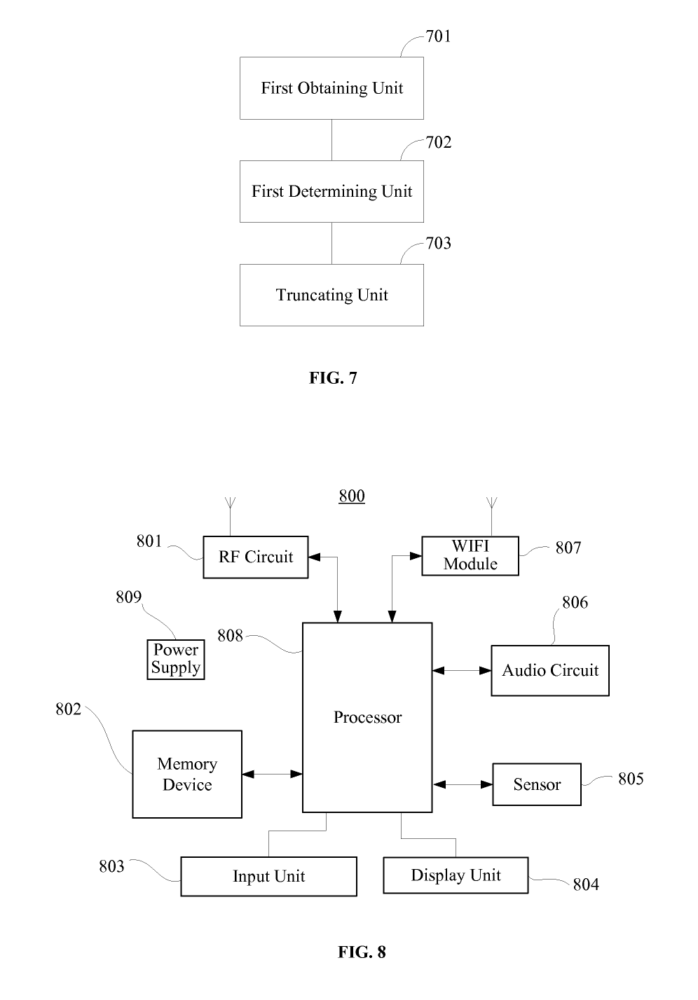

Accordingly, FIG. 7 is a schematic diagram of the apparatus for truncating character string in this embodiment. The exemplary apparatus can include a first obtaining unit 701, a first determining unit 702, and/or a truncating unit 703.

The first obtaining unit 701 is configured to read a character string to be truncated to obtain a byte length occupied by a current character. The first determining unit 702 is configured to determine whether a substring, formed from a starting character of the character string to be truncated to the current character, satisfies a pre-set truncating condition.

The truncating unit 703 is configured to subtract the current character from the substring as a truncated substring for displaying according to the byte length occupied by the current character, when the substring, formed from the starting character of the character string to be truncated to the current character, satisfies the pre-set truncating condition.

In various embodiments, the apparatus for truncating character string can further include a displaying unit. The displaying unit is configured, when the substring, formed from the starting character of the character string to be truncated to the current character, does not satisfy the pre-set truncating condition, to use a next character following the current character as another current character to repeat steps (a)-(d) performed by the first obtaining unit, the first determining unit, and the truncating unit 703 until the character string to be truncated satisfies the pre-set truncating condition, and then to display the character string to be truncated.

In various embodiments, the exemplary apparatus for truncating character string can further include a second obtaining unit. The second obtaining unit is configured to obtain an actually-displayed pixel width of the substring, formed from the starting character of the character string to be truncated to the current character.

For example, the first determining unit can be configured: to determine whether an actually-displayed pixel width of the substring, formed from the starting character of the character string to be truncated to the current character, is greater than a pre-set maximum pixel width. When the actually-displayed pixel width is greater than the pre-set maximum pixel width, the pre-set truncating condition is satisfied. When the actually-displayed pixel width is not greater than the pre-set maximum pixel width, the pre-set truncating condition is unsatisfied.

In various embodiments, the first determining unit can be configured: to determine whether a total byte length occupied by the substring, formed from the starting character of the character string to be truncated to the current character, is greater than a pre-set maximum byte length. When the total byte length occupied by the substring is greater than the pre-set maximum byte length, the pre-set truncating condition is satisfied. When the total byte length occupied by the substring is not greater than the pre-set maximum byte length, the pre-set truncating condition is unsatisfied.

In various embodiments, the first obtaining unit can be configured to directly obtain the byte length occupied by each character according to a coding type of the character string to be truncated, when the character string to be truncated uses fixed-length coding. Alternatively, the first obtaining unit is configured to obtain the byte length occupied by the current character according to a first byte of the current character, when the character string to be truncated uses variable-length coding.

In various embodiments, the exemplary apparatus for truncating character string can further include: a second determining unit. The second determining unit is configured to determine whether the character string to be truncated satisfies the pre-set truncating condition. When the character string to be truncated satisfies the pre-set truncating condition, the first obtaining unit obtains the byte length occupied by the current character. When the character string to be truncated does not satisfy the pre-set truncating condition, the character string to be truncated is directly displayed.

In various embodiments, the second determining unit is configured to obtain an actually-displayed pixel width of the character string to be truncated, and to determine whether the actually-displayed pixel width of the character string to be truncated is greater than a pre-set maximum pixel width. When the actually-displayed pixel width is greater than the pre-set maximum pixel width, the first obtaining unit obtains the byte length occupied by the current character. When the actually-displayed pixel width is not greater than the pre-set maximum pixel width, the character string to be truncated is directly displayed.

In various embodiments, the second determining unit is configured to determine whether a total byte length occupied by the character string to be truncated is greater than a pre-set maximum byte length. When the total byte length occupied by the character string to be truncated is greater than the pre-set maximum byte length, the first obtaining unit obtains the byte length occupied by the current character. When the total byte length occupied by the character string to be truncated is not greater than the pre-set maximum byte length, the character string to be truncated is directly displayed.

As such, the disclosed method can dynamically obtain the byte length occupied by each character of the character string to be truncated. When truncating the character string, when a substring (e.g., formed from the starting character of the character string to be truncated to the current character) satisfies a pre-set truncating condition, the current character can be subtracted from the substring as the truncated substring for displaying to ensure a complete character without having error code. In addition, according to an actual pixel width of the character, a maximum pixel width can be set to truncate the character string, to ensure the displayed-width service of the character string (containing different types of characters) after a final truncation is in line with the requirement set by the text control width.

FIG. 8 is a structural diagram of an exemplary terminal device 800 consistent with various disclosed embodiments. The disclosed apparatus can be included in the exemplary terminal device 800.

The exemplary terminal device 800 can include an RF (Radio Frequency) circuit 801, a memory device 802 including one or more computer-readable storage media, an input unit 803, a display unit 804, a sensor 805, an audio circuit 806, a WIFI (Wireless Fidelity) module 807, a processor 808 including one or more processing cores, a power supply 809, and/or other components. In various embodiments, the terminal device(s) described herein can include more or less components as depicted in FIG. 8. Certain parts can be omitted, combined, replaced, and added.

The RF circuit 801 may be used to send and receive information or send and receive signal during communication. In particular, after receiving downlink information from a base station, such information can be processed by the one or more processors 808. Further, the data related to the uplink can be sent to the base station. Generally, the RF circuit 801 can include, but be not limited to, an antenna, at least one amplifier, a tuner, one or more oscillators, user identity module (SIM) card, a transceiver, a coupler, LNA (i.e., Low Noise Amplifier), duplexer, etc. In addition, the RF circuit 801 may communicate with other devices via a wireless communication network. The wireless communication may use any communication standards or protocols, including but not limited to, GSM (Global System for Mobile Communications), GPRS (General Packet Radio Service), CDMA (Code Division Multiple Access), WCDMA (Wideband Code Division Multiple Access), LTE (Long Term Evolution), e-mail, SMS (Short Messaging Service), etc.

The memory device 802 can be used for storing software programs and modules, such as those software programs and modules corresponding to the terminal device and the third party service provider as described in FIGS. 3-5 for business processing. By running software programs and modules stored in the memory device 802, the processor 808 can perform various functional applications and data processing to achieve business processing. The memory device 802 can include a program storage area and a data storage area. The program storage area can store the operating system, applications (such as sound playback, image playback, etc.) required by at least one function. The data storage area can store data (such as audio data, phone book, etc.) created when using the terminal device 800. In addition, the memory device 802 may include a high-speed random access memory, a non-volatile memory, such as at least one disk memory, flash memory, and/or other volatile solid-state memory elements. Accordingly, the memory device 802 may further include a memory controller to provide the processor 808 and the input unit 803 with access to the memory device 802.

The input unit 803 can be used to receive inputted numeric or character information, and to generate signal input of keyboard, mouse, joystick, and trackball or optical signal input related to the user settings and function controls. Specifically, the input unit 803 may include a touch sensitive surface and other input device(s). The touch-sensitive surface, also known as a touch screen or touch panel, may collect touch operations that a user conducts on or near the touch-sensitive surface. For example, a user may use a finger, a stylus, and any other suitable object or attachment on the touch-sensitive surface or on an area near the touch-sensitive surface. The touch-sensitive surface may drive a connecting device based on a preset program. Optionally, the touch sensitive surface may include a touch detection device and a touch controller. The touch detection device can detect user's touch position and detect a signal due to a touch operation and send the signal to the touch controller. The touch controller can receive touch information from the touch detection device, convert the touch information into contact coordinates to send to the processor 808, and receive commands sent from the processor 808 to execute. Furthermore, the touch sensitive surface can be realized by resistive, capacitive, infrared surface acoustic wave, and/or other types of surface touch. In addition to the touch sensitive surface, the input unit 803 may also include other input device(s). Specifically, the other input device(s) may include, but be not limited to, a physical keyboard, function keys (such as volume control buttons, switch buttons, etc.), a trackball, a mouse, an operating lever, or combinations thereof.

The display unit 804 can be used to display information inputted by the user, information provided to the user, and a variety of graphical user interfaces of the terminal device 800. These graphical user interfaces can be formed by images, text, icons, videos, and/or any combinations thereof. The display unit 804 may include a display panel configured by, e.g., LCD (Liquid Crystal Display), OLED (Organic Light-Emitting Diode), etc. Further, the touch sensitive surface may cover the display panel 81. When the touch sensitive surface detects a touch operation on or near the touch sensitive surface, the touch operation can be sent to the processor 808 to determine a type of the touch operation. Accordingly, the processor 808 can provide visual output on the display panel 81. Although in FIG. 8 the touch-sensitive surface and the display panel are shown as two separate components to achieve input and output functions, in some embodiments, the touch sensitive surface and the display panel can be integrated to perform input and output functions.

The terminal device 800 may further include at least one sensor 805, such as optical sensors, motion sensors, and other suitable sensors. Specifically, the optical sensors may include an ambient optical sensor and a proximity sensor. The ambient optical sensor may adjust brightness of the display panel according to the brightness of ambient light. The proximity sensor can turn off the display panel and/or turn backlighting, when the terminal device 800 moves to an ear. As a type of motion sensor, a gravity sensor may detect amount of an acceleration in each direction (e.g., including three axis) and detect magnitude and direction of gravity when in stationary. The gravity sensor can be used to identify phone posture (for example, switching between horizontal and vertical screens, related games, magnetometer calibration posture, etc.), vibration recognition related functions (e.g., pedometer, percussion, etc.), etc. The terminal device 800 can also be configured with, e.g., a gyroscope, a barometer, a hygrometer, a thermometer, an infrared sensor, and/or other sensors.

The audio circuit 806, the speaker, and the microphone may provide an audio interface between the user and terminal device 800. The audio circuit 806 may transmit an electrical signal converted from the received audio data to the speaker to convert into audio signal output. On the other hand, the microphone can convert the collected sound signal to an electrical signal, which can be received by the audio circuit 806 to convert into audio data. The audio data can be output to the processor 808 for processing and then use the RF circuit 801 to transmit to, e.g., another terminal device. Alternatively, the audio data can be output to the memory device 802 for further processing. The audio circuit 806 may also include an earplug jack to provide communications between the peripheral headset and the terminal device 800.

WiFi is used as a short-range wireless transmission technology. The terminal device 800 may use the WIFI module 807 to help users send and receive emails, browse websites, access streaming media, etc. The WIFI module 807 can provide users with a wireless or wired broadband Internet access. In various embodiments, the transport module 807 can be configured within or outside of the terminal device 800 as depicted in FIG. 8.

The processor 808 can be a control center of the terminal device 800: using a variety of interfaces and circuits to connect various parts, e.g., throughout a mobile phone; running or executing software programs and/or modules stored in the memory device 802; calling the stored data in the memory device 802; and/or performing various functions and data processing of the terminal device 800 to monitor the overall mobile phone. Optionally, the processor 808 may include one or more processing cores. In an exemplary embodiment, the processor 808 may integrate application processor with modulation and demodulation processor. The application processor is mainly used to process operating system, user interface, and applications. The modulation and demodulation processor is mainly used to deal with wireless communications. In various embodiments, the modulation and demodulation processor may or may not be integrated into the processor 808.

The terminal device 800 may further include a power supply 809 (such as a battery) to power various components of the terminal device. In an exemplary embodiment, the power supply can be connected to the processor 808 via the power management system, and thus use the power management system to manage charging, discharging, and/or power management functions. The power supply 809 may also include one or more DC or AC power supplies, a recharging system, a power failure detection circuit, a power converter or inverter, a power status indicator and/or any other suitable components.

Although not shown in FIG. 8, the terminal device 800 can further include a camera, a Bluetooth module, etc. without limitation. Specifically, the terminal device can have a display unit of a touch screen display, a memory, and one or more programs stored in the memory. The terminal device can be configured to use one or more processor to execute the one or more programs stored in the memory. For example, such execution may include: (a) reading a character string to be truncate; (b) obtaining a byte length occupied by a current character; (c) determining whether a substring, formed from a starting character of the character string to be truncated to the current character, satisfies a pre-set truncating condition; and (d) subtracting the current character from the substring to generate a truncated substring for displaying, when the substring, formed from the starting character of the character string to be truncated to the current character, satisfies the pre-set truncating condition, according to the byte length occupied by the current character.

When the substring, formed from the starting character of the character string to be truncated to the current character, does not satisfy the pre-set truncating condition, a next character following the current character is used as another current character to repeat steps (b)-(d) until the character string to be truncated satisfies the pre-set truncating condition, and then displaying the character string to be truncated.

Optionally, an actually-displayed pixel width of the substring, formed from the starting character of the character string to be truncated to the current character is obtained. The step (c) of determining whether the substring, formed from the starting character of the character string to be truncated to the current character, satisfies the pre-set truncating condition includes: determining whether an actually-displayed pixel width of the substring, formed from the starting character of the character string to be truncated to the current character, is greater than a pre-set maximum pixel width. When the actually-displayed pixel width is greater than the pre-set maximum pixel width, the pre-set truncating condition is satisfied. When the actually-displayed pixel width is not greater than the pre-set maximum pixel width, the pre-set truncating condition is unsatisfied.

The step (c) of determining whether the substring formed from the starting character of the character string to be truncated to the current character satisfies the pre-set truncating condition includes: determining whether a total byte length occupied by the substring, formed from the starting character of the character string to be truncated to the current character, is greater than a pre-set maximum byte length. When the total byte length occupied by the substring is greater than the pre-set maximum byte length, the pre-set truncating condition is satisfied. When the total byte length occupied by the substring is not greater than the pre-set maximum byte length, the pre-set truncating condition is unsatisfied.

The step (b) of obtaining the byte length occupied by the current character includes: directly obtaining the byte length occupied by each character according to a coding type of the character string to be truncated, when the character string to be truncated uses fixed-length coding.

The step (b) of obtaining the byte length occupied by the current character includes: obtaining the byte length occupied by the current character according to a first byte of the current character, when the character string to be truncated uses variable-length coding.

After the step (a) of reading the character string to be truncated, the method further includes: determining whether the character string to be truncated satisfies the pre-set truncating condition. When the character string to be truncated satisfies the pre-set truncating condition, steps (b)-(d) is performed. When the character string to be truncated does not satisfy the pre-set truncating condition, the character string to be truncated is displayed directly.

To determining whether the character string to be truncated satisfies the pre-set truncating condition, an actually-displayed pixel width of the character string to be truncated is obtained. It is determined whether the actually-displayed pixel width of the character string to be truncated is greater than a pre-set maximum pixel width.

To determining whether the character string to be truncated satisfies the pre-set truncating condition, whether a total byte length occupied by the character string to be truncated is greater than a pre-set maximum byte length is determined.

As such, the disclosed method can dynamically obtain the byte length occupied by each character of the character string to be truncated. When truncating the character string, when a substring (e.g., formed from the starting character of the character string to be truncated to the current character) satisfies a pre-set truncating condition, the current character can be subtracted from the substring as the truncated substring for displaying to ensure a complete character without having error code. In addition, according to an actual pixel width of the character, a maximum pixel width can be set to truncate the character string, to ensure the displayed-width service of the character string (containing different types of characters) after a final truncation is in line with the requirement set by the text control width.

It should be noted that, in the present disclosure each embodiment is progressively described, i.e., each embodiment is described and focused on difference between embodiments. Similar and/or the same portions between various embodiments can be referred to with each other. In addition, exemplary apparatus is described with respect to corresponding methods.

The disclosed methods, and/or apparatus can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The apparatus, devices, and/or methods can be implemented in a software manner. Of course, the apparatus, devices, and/or methods can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and apparatus. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods, apparatus, and terminal devices for truncating a character string are provided. Exemplary method can include exemplary steps (a)-(d). A character string to be truncate is read (a) and a byte length occupied by a current character is obtained (b). It is determined whether a substring, formed from a starting character of the character string to be truncated to the current character, satisfies a pre-set truncating condition (c). When the substring, formed from the starting character of the character string to be truncated to the current character, satisfies the pre-set truncating condition, the current character is subtracted from the substring to generate a truncated substring for displaying, according to the byte length occupied by the current character (d).

With respect to a different character code, a byte length occupied by each character can be dynamically determined to ensure the truncated character is a complete (or full) character to avoid error code displayed from a truncated substring. In addition, by using a pre-set maximum pixel width as a pre-set truncating condition, the truncated substring is ensured not to exceed a pre-set text control width.

As such, the disclosed methods and apparatus can dynamically obtain the byte length occupied by each character of the character string to be truncated. When truncating the character string, when a substring (e.g., formed from the starting character of the character string to be truncated to the current character) satisfies a pre-set truncating condition, the current character can be subtracted from the substring as the truncated substring for displaying to ensure a complete character without having error code. In addition, according to an actual pixel width of the character, a maximum pixel width can be set to truncate the character string, to ensure the displayed-width service of the character string (containing different types of characters) after a final truncation is in line with the requirement set by the text control width.

What is claimed is:

1. A method for truncating a character string, comprising:
(a) reading a character string to be truncate;
(b) obtaining a byte length occupied by a current character;
(c) determining whether a substring, formed from a starting character of the character string to be truncated to the current character, satisfies a pre-set truncating condition; and
(d) subtracting the current character from the substring to generate a truncated substring for displaying, when the substring, formed from the starting character of the character string to be truncated to the current character, satisfies the pre-set truncating condition, according to the byte length occupied by the current character.

2. The method according to claim 1, further comprising:
when the substring, formed from the starting character of the character string to be truncated to the current character, does not satisfy the pre-set truncating condition, using a next character following the current character as another current character to repeat steps (b)-(d) until the character string to be truncated satisfies the pre-set truncating condition, and then displaying the character string to be truncated.

3. The method according to claim 1, further comprising:
obtaining an actually-displayed pixel width of the substring, formed from the starting character of the character string to be truncated to the current character.

4. The method according to claim 3, wherein the step (c) of determining whether the substring, formed from the starting character of the character string to be truncated to the current character, satisfies the pre-set truncating condition comprises:
determining whether an actually-displayed pixel width of the substring, formed from the starting character of the character string to be truncated to the current character, is greater than a pre-set maximum pixel width,
wherein, when the actually-displayed pixel width is greater than the pre-set maximum pixel width, the pre-set truncating condition is satisfied, and when the actually-displayed pixel width is not greater than the pre-set maximum pixel width, the pre-set truncating condition is unsatisfied.

5. The method according to claim 1, wherein the step (c) of determining whether the substring formed from the starting character of the character string to be truncated to the current character satisfies the pre-set truncating condition comprises:
determining whether a total byte length occupied by the substring, formed from the starting character of the character string to be truncated to the current character, is greater than a pre-set maximum byte length,
wherein when the total byte length occupied by the substring is greater than the pre-set maximum byte length, the pre-set truncating condition is satisfied, and when the total byte length occupied by the substring is not greater than the pre-set maximum byte length, the pre-set truncating condition is unsatisfied.

6. The method according to claim 1, wherein the step (b) of obtaining the byte length occupied by the current character comprises:
when the character string to be truncated uses fixed-length coding, directly obtaining the byte length occupied by each character according to a coding type of the character string to be truncated.

7. The method according to claim 1, wherein the step (b) of obtaining the byte length occupied by the current character comprises:
when the character string to be truncated uses variable-length coding, obtaining the byte length occupied by the current character according to a first byte of the current character.

8. The method according to claim 1, wherein, after the step (a) of reading the character string to be truncated, the method further comprises:
determining whether the character string to be truncated satisfies the pre-set truncating condition,
wherein when the character string to be truncated satisfies the pre-set truncating condition, continuing to perform steps (b)-(d); and when the character string to be truncated does not satisfy the pre-set truncating condition, displaying the character string to be truncated directly.

9. The method according to claim 8, wherein determining whether the character string to be truncated satisfies the pre-set truncating condition comprises:
obtaining an actually-displayed pixel width of the character string to be truncated; and
determining whether the actually-displayed pixel width of the character string to be truncated is greater than a pre-set maximum pixel width.

10. The method according to claim 8, wherein determining whether the character string to be truncated satisfies the pre-set truncating condition comprises:
determining whether a total byte length occupied by the character string to be truncated is greater than a pre-set maximum byte length.

11. An apparatus of truncating a character string, comprising:
a first obtaining unit, configured to read a character string to be truncated to obtain a byte length occupied by a current character;
a first determining unit, configured to determine whether a substring, formed from a starting character of the character string to be truncated to the current character, satisfies a pre-set truncating condition; and
a truncating unit, configured to subtract the current character from the substring as a truncated substring for displaying according to the byte length occupied by the current character, when the substring, formed from the starting character of the character string to be truncated to the current character, satisfies the pre-set truncating condition.

12. The apparatus according to claim 11, further comprising:
a displaying unit configured, when the substring, formed from the starting character of the character string to be truncated to the current character, does not satisfy the pre-set truncating condition, to use a next character following the current character as another current character to repeat steps (b)-(d) performed by the first obtaining unit, the first determining unit, and the truncating unit until the character string to be truncated satisfies the pre-set truncating condition, and then to display the character string to be truncated.

13. The apparatus according to claim 11, further comprising:
a second obtaining unit, configured to obtain an actually-displayed pixel width of the substring, formed from the starting character of the character string to be truncated to the current character.

14. The apparatus according to claim 13, wherein the first determining unit is configured to determine whether an actually-displayed pixel width of the substring, formed from the starting character of the character string to be truncated to the current character, is greater than a pre-set maximum pixel width,
wherein when the actually-displayed pixel width is greater than the pre-set maximum pixel width, the pre-set truncating condition is satisfied; and when the actually-displayed pixel width is not greater than the pre-set maximum pixel width, the pre-set truncating condition is unsatisfied.

15. The apparatus according to claim 11, wherein the first determining unit is configured to determine whether a total byte length occupied by the substring, formed from the starting character of the character string to be truncated to the current character, is greater than a pre-set maximum byte length,
wherein when the total byte length occupied by the substring is greater than the pre-set maximum byte length, the pre-set truncating condition is satisfied; and when the total byte length occupied by the substring is not greater than the pre-set maximum byte length, the pre-set truncating condition is unsatisfied.

16. The apparatus according to claim 11, wherein the first obtaining unit is configured to directly obtain the byte length occupied by each character according to a coding type of the character string to be truncated, when the character string to be truncated uses fixed-length coding.

17. The apparatus according to claim 11, wherein the first obtaining unit is configured to obtain the byte length occupied by the current character according to a first byte of the current character, when the character string to be truncated uses variable-length coding.

18. The apparatus according to claim 11, further comprising:
a second determining unit, configured to determine whether the character string to be truncated satisfies the pre-set truncating condition; wherein when the character string to be truncated satisfies the pre-set truncating condition, the first obtaining unit obtains the byte length occupied by the current character; and when the character string to be truncated does not satisfy the pre-set truncating condition, the character string to be truncated is directly displayed.

19. The apparatus according to claim 18, wherein the second determining unit is configured:
to obtain an actually-displayed pixel width of the character string to be truncated; and
to determine whether the actually-displayed pixel width of the character string to be truncated is greater than a pre-set maximum pixel width, wherein when the actually-displayed pixel width is greater than the pre-set maximum pixel width, the first obtaining unit obtains the byte length occupied by the current character; and when the actually-displayed pixel width is not greater than the pre-set maximum pixel width, the character string to be truncated is directly displayed.

20. The apparatus according to claim 18, wherein the second determining unit is configured to determine whether a total byte length occupied by the character string to be truncated is greater than a pre-set maximum byte length,
wherein when the total byte length occupied by the character string to be truncated is greater than the pre-set maximum byte length, the first obtaining unit obtains the byte length occupied by the current character; and when the total byte length occupied by the character string to be truncated is not greater than the pre-set maximum byte length, the character string to be truncated is directly displayed.
